(19) United States
(12) Patent Application Publication
(10) Pub. No.: US 2026/0290669 A1
(43) Pub. Date: Sep. 24, 2026

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yoshinori TAKAI, Mie (JP); Shinichiro YAMAMOTO, Mie (JP)

(21) Appl. No.: 19/167,841

(22) PCT Filed: Mar. 12, 2024
(86) PCT No.: PCT/JP2024/009637

§ 371 Date: Sep. 23, 2025

(30) Foreign Application Priority Data
Mar. 30, 2023 (JP) 2023-056424

(51) Int. Cl. H01F 27/24; H01F 27/28

(52) U.S. Cl. CPC H01F 27/24; H01F 27/28

(57) ABSTRACT

A reactor includes: a coil including a winding part; a magnetic core including an inner core part disposed inside the winding part; a first spacer disposed between the winding part and the inner core part; and a mold member that integrates the coil and the magnetic core into a single piece, wherein the inner core part has a quadrangular prism shape, and includes a first core portion having a first end face, and a second core portion having a second end face spaced apart from the first end face, the first spacer has a trough shape including an inner peripheral surface opposed to three outer peripheral surfaces of the inner core part, and a portion of the mold member is disposed in a first clearance between the winding part and a portion of the inner core part to which the inner peripheral surface is not opposed.

### TECHNICAL FIELD

The present disclosure relates to a reactor, a converter, and a power conversion device.

This application is based upon and claims the benefit of priority from the corresponding Japanese Patent Application No. 2023-056424 filed on Mar. 30, 2023, the entire contents of which are incorporated herein by reference.

### BACKGROUND

Patent Document 1 discloses a reactor that includes a coil including a winding part, and a magnetic core. The magnetic core includes a middle core part disposed inside the winding part. The middle core part is composed of a first middle core piece and a second middle core piece. Inside the winding part, an end face of the first middle core piece and an end face of the second middle core piece are spaced apart from each other.

The reactor further includes a molded resin part that covers at least a portion of the magnetic core. The molded resin part corresponds to a mold member in the present specification. At the time of forming the molded resin part, a resin that forms the molded resin part enters a clearance (hereinafter referred to as a clearance A) between the winding part and the inner core part from the position of an end face of the winding part, and reaches a clearance (hereinafter referred to as a clearance B) between the end face of the first middle core piece and the end face of the second middle core piece. The molded resin part that has entered the clearance B functions as a resin gap that adjusts the magnetic properties of the magnetic core. The resin gap formed by a portion of the molded resin part can be regarded as a portion of the inner core part.

### PRIOR ART DOCUMENT

### Patent Document

Patent Document 1: JP 2021-141123 A

### Summary of the Invention

A reactor according to the present disclosure includes includes: a coil including a winding part; a magnetic core including an inner core part disposed inside the winding part, and an outer core part disposed outside the winding part; a first spacer disposed between the winding part and the inner core part; and a mold member that integrates the coil and the magnetic core into a single piece. The inner core part has a quadrangular prism shape, and includes a first core portion having a first end face disposed inside the winding part, and a second core portion having a second end face spaced apart from the first end face. The first spacer has a trough shape including an inner peripheral surface opposed to three outer peripheral surfaces of the inner core part. A portion of the mold member is disposed in a first clearance between the winding part and a portion of the inner core part to which the inner peripheral surface is not opposed, and a second clearance between the first end face and the second end face.

### BRIEF DESCRIPTION OF THE DRAWINGS

FIG. 1 is a schematic perspective view of a reactor described in Embodiment 1.

FIG. 2 is an exploded perspective view of the reactor excluding a mold member.

FIG. 3 is a cross-sectional view taken along the line III-III in FIG. 1.

FIG. 4 is a cross-sectional view taken along the line IV-IV in FIG. 3.

FIG. 5 is a configuration diagram schematically showing a power system of a hybrid automobile.

FIG. 6 is a circuit diagram showing an example of a power conversion device including a converter.

### DETAILED DESCRIPTION TO EXECUTE THE INVENTION

### Problems to be Solved by the Present Disclosure

In order to reduce the size of the reactor and improve the heat dissipation of the reactor, there is a need to reduce the clearance A between the winding part and the middle core part, and reduce the clearance B between the end face of the first middle core piece and the end face of the second middle core piece inside the winding part. In such a case, the resin is difficult to be filled into the clearance A. Also, the resin is difficult to be filled into the clearance B through the clearance A since the clearance and the clearance B are orthogonal to each other. If voids are formed in the clearance B due to insufficient filling of the resin into the clearance B, the heat dissipation of the reactor may be reduced, or the function of the resin gap may be degraded. If the pressure of the resin at the time of molding the coil and the magnetic core from outside is excessively increased in order to sufficiently fill the resin into the clearance B, the magnetic core may be cracked by the pressure of the resin.

An object of the present disclosure is to provide a reactor in which a portion of a mold member that integrates a coil and a magnetic core into a single piece is easily filled into the winding part.

### Effects of the Present Disclosure

A reactor according to the present disclosure is a reactor in which a portion of a mold member that integrates a coil and a magnetic core into a single piece is sufficiently filled into a winding part.

### Description of Embodiments of the Present Disclosure

First, aspects of the present disclosure will be listed and described

(1) A reactor according to an embodiment includes: a coil including a winding part; a magnetic core including an inner core part disposed inside the winding part, and an outer core part disposed outside the winding part; a first spacer disposed between the winding part and the inner core part; and a mold member that integrates the coil and the magnetic core into a single piece. The inner core part has a quadrangular prism shape, and includes a first core portion having a first end face disposed inside the winding part, and a second core portion having a second end face spaced apart from the first end face. The first spacer has a trough shape including an inner peripheral surface opposed to three outer peripheral surfaces of the inner core part. A portion of the mold member is disposed in a first clearance between the winding part and a portion of the inner core part to which the inner peripheral surface is not opposed, and a second clearance between the first end face and the second end face.

In the reactor according to the embodiment, the first spacer having a trough shape is disposed in the clearance between the winding part and the inner core part having a quadrangular prism shape, and the first spacer closes a portion of the clearance. The clearance narrowed by the first spacer constitutes the first clearance through which the resin that forms the mold member passes at the time of forming the mold member. In the first clearance constituted by the narrowed clearance, the filling pressure of the resin is easily kept high. Accordingly, the resin is easily filled into the first clearance without the pressure of the resin having to be increased at the time of molding the coil and the magnetic core from outside. The high-pressure resin that has passed through the first clearance easily enters the second clearance formed between the first end face of the first core portion forming the inner core part, and the second end face of the second core portion. Since the pressure of the resin at the time of molding the coil and the magnetic core from outside is not excessively increased, damage to the magnetic core due to the resin pressure is suppressed. In the reactor according to the embodiment, the resin is sufficiently filled into the first clearance and the second clearance, and defects such as voids are less likely to be formed in the mold member disposed in the second clearance. A portion of the mold member that is disposed in the second clearance and has less defects achieves the desired property as the resin gap.

The mold member functions as a transmission path for the heat from the inside of the winding part toward the outside. When the mold member has fewer defects such as voids inside the winding part, the function of the mold member as the heat transmission path is less likely to be degraded due to such defects.

By securing an electrical insulation distance between the winding part and the inner core part by a portion of the mold member and the first spacer, it is possible to reduce the distance between the winding part and the inner core part. As a result, it is possible to reduce the size of the winding part. Therefore, the reactor according to the embodiment is small.

(2) In the reactor described in (1) above, the first spacer may cover 45% or more of a perimeter of the inner core part.

The perimeter of the inner core part is the length of a contour line of the inner core part taken along a cross section orthogonal to the axis of the inner core part. When the first spacer covers 45% or more of the perimeter of the inner core part, the filling pressure of the resin in the first clearance is kept high, and the resin easily spreads throughout the second clearance.

(3) In the reactor described in (1) or (2) above, the reactor may further include a second spacer disposed between an end face of the winding part and the outer core part, wherein the first spacer and the second spacer may constitute a single integral piece.

The second spacer can ensure a sufficient electrical insulation distance between the end face of the winding part and the outer core part. When the first spacer and the second spacer constitute a single integral piece, the position of the first spacer inside the winding part is easily fixed at the time of producing the reactor. Therefore, the first spacer is less likely to move when the resin that forms the mold member is filled into the winding part.

(4) In the reactor described in any one of (1) to (3) above, the first spacer may have a thickness of 0.5 mm or more and 2.0 mm or less.

When the thickness of the first spacer is 0.5 mm or more, a sufficient electrical insulation distance is secured between the winding part and the inner core part. When the thickness of the first spacer is 2.0 mm or less, the heat of the inner core part easily escapes to the winding part. Accordingly, the heat dissipation of the reactor is improved. The thickness of the first spacer being 2.0 mm or less means that the winding part is small. Therefore, a reactor including a first spacer having a thickness of 2.0 mm or less is small.

(5) In the reactor described in any of (1) to (4) above, the first clearance may have a width of 0.5 mm or more and 4.0 mm or less.

The width of the first clearance is the distance between the outer peripheral surfaces of the inner core part and the inner peripheral surface of the winding part. When the width of the first clearance is 0.5 mm or more, the resin that forms the mold member is easily disposed in the first clearance at the time of forming the mold member. When the width of the first clearance is 4.0 mm or less, the heat of the inner core part easily escapes to the winding part. Accordingly, the heat dissipation of the reactor is improved. “The width of the first clearance being 4.0 mm or less” means that the winding part is small. Therefore, a reactor including a first clearance having a width of 4.0 mm or less is small.

(6) In the reactor described in any of (1) to (5) above, the second clearance may have a width of 0.8 mm or more and 4.0 mm or less.

When the width of the second clearance is 0.8 mm or more, the resin that forms the mold member is easily disposed in the second clearance at the time of forming the mold member. When the width of the second clearance is 4.0 mm or less, the leakage of magnetic flux in the second clearance is reduced. Accordingly, the loss due to leaking magnetic flux is reduced.

(7) In the reactor described in any of (1) to (6) above, the magnetic core may be formed by combining a first core piece including a portion of the outer core part and the first core portion, and a second core piece including a portion of the outer core part and the second core portion.

As a result of the magnetic core being composed of two core pieces, the operation of mounting the magnetic core to the coil is facilitated at the time of producing the reactor. Accordingly, the productivity of the reactor is improved.

(8) A converter according to an embodiment includes the reactor described in any one of (1) to (7) above.

The reactor according to the embodiment is small. Therefore, a converter including the reactor according to the embodiment is also small. The reactor according to the embodiment has excellent heat dissipation. Therefore, a converter including the reactor according to the embodiment operates stably.

(9) A power conversion device according to an embodiment include the converter described in (8) above.

A power conversion device including the converter according to the embodiment is small and operates stably.

### DETAILS OF EMBODIMENTS OF THE PRESENT DISCLOSURE

Embodiments of a reactor, a converter, and a power conversion device according to the present disclosure will be described below with reference to the drawings. In the drawings, the same reference numerals denote the same components. It should be noted that the present invention is not limited to the configurations described in the embodiments, but is defined by the claims, and is intended to include all modifications which fall within the scope of the claims and the meaning and scope of equivalents thereof.

### Embodiment 1

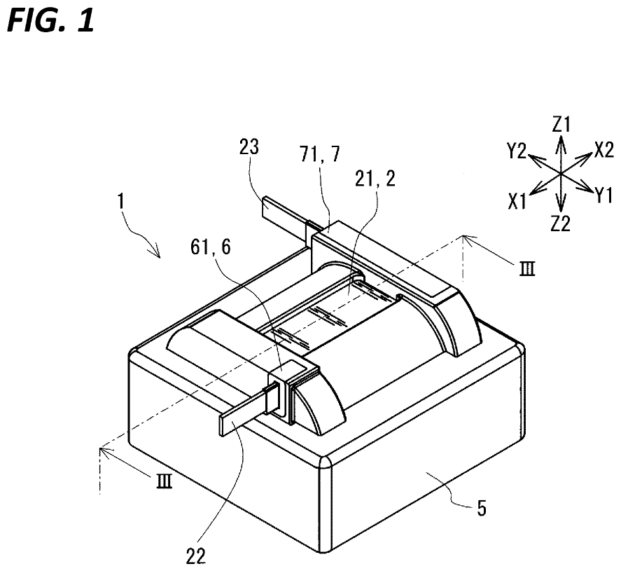

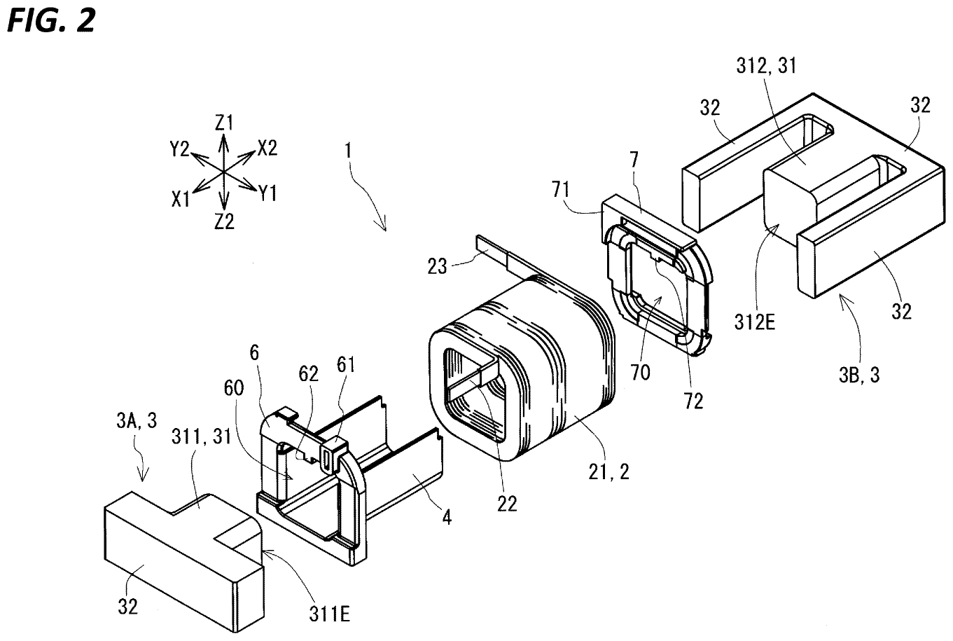

A reactor 1 according to the present embodiment shown in FIGS. 1 and 2 includes a coil 2, a magnetic core 3, a first spacer 4, and a mold member 5. A feature of the present embodiment lies in the arrangement and the shape of the first spacer 4, as well as the formation state of the mold member 5. The details of the reactor 1 according to the present embodiment will be described below.

### <<Coil>>

As shown in FIG. 2, the coil 2 includes at least one winding part 21. The coil 2 of the present embodiment includes one winding part 21. The winding part 21 is formed by spirally winding a winding wire. A known winding wire can be used as the winding wire. The winding wire of the present embodiment is a coated flat rectangular wire made of a conductive wire including insulating coating. The conductive wire is formed by, for example, a flat rectangular wire made of copper. The insulating coating is made of enamel, for example. The winding part 21 of the present embodiment is an edgewise coil formed by winding the coated flat rectangular wire in an edgewise manner.

The winding part 21 has a rectangular tubular shape. That is, end faces of the winding part 21 of the present embodiment have a rectangular frame shape. Corner portions of the winding part 21 of the present embodiment are rounded. Since the winding part 21 has a rectangular tubular shape, the contact area between the winding part 21 and the installation target is more likely to be increased than in a case where the winding part has a cylindrical shape having the same cross-sectional area. Therefore, the reactor 1 easily dissipates heat to the installation target via the winding part 21. In addition, the state of installation of the winding part 21 on the installation target is easily stabilized.

Here, directions of the reactor 1 will be defined with respect to the coil 2. First, an X1 direction is a direction from a first end portion toward a second end portion of the winding part 21 along an axis of the winding part 21. An Yl direction is a direction from a first side surface toward a second side surface of the winding part 21. A Z1 direction is a direction from a bottom surface toward an upper surface of the winding part 21. The X1 direction, the Y1 direction, and the Z1 direction are orthogonal to each other. An X2 direction, an Y2 direction, and a Z2 direction are a direction opposite to the X1 direction, a direction opposite to the Y1 direction, and a direction opposite to the Z1 direction, respectively.

In the present embodiment, an end portion 22 of the winding wire disposed in the X1 direction of the winding part 21 is drawn from the winding part 21 toward the X1 direction. In the present embodiment, an end portion 23 disposed in the X2 direction of the winding part 21 is drawn toward the Y2 direction. At the end portions 22 and 23, the insulating coating is stripped off to expose the conductive wires. A terminal member (not shown) is connected to each of the exposed conductive wires.

Unlike the present embodiment, in a case where there are two winding parts 21, the two winding parts 21 may be connected to power supplies that are independent of each other, or may be connected to one power supply.

### <<Magnetic Core>>

The magnetic core 3 is a magnetic substance that forms a closed magnetic circuit thereinside. The magnetic core 3 is a powder compact, or a molded body of a composite material. The magnetic core 3 may be formed by combining a core piece made of a powder compact, and a core piece made of a molded body of a composite material, or may be formed by covering, with a composite material, the outer periphery of a core piece made of a powder compact.

The powder compact is obtained by compression molding raw material powder including soft magnetic powder. The soft magnetic powder is made of pure iron or an iron alloy, for example. The iron alloy is, for example, an Fe (iron)-Si (silicon) alloy, or an Fe—Ni (nickel) alloy. The raw material powder may contain a lubricant. The content of the powder compact in the soft magnetic powder is, for example, greater than 80 vol %, and, further, 85 vol % or more, based on the total volume of the powder compact taken as 100 vol %.

The molded body of the composite material is obtained by filling a mixture of soft magnetic powder and an unsolidified resin into a mold, and solidifying the resin. In the molded body of the composite material, the soft magnetic powder is dispersed in the resin. The resin is, for example, a polyphenylene sulfide (PPS) resin, a polytetrafluoroethylene (PTFE) resin, a liquid crystal polymer (LCP), a polyamide (PA) resin such as nylon 6 or nylon 66, a polybutylene terephthalate (PBT) resin, or an acrylonitrile-butadiene-styrene (ABS) resin. The resin may be a bulk molding compound (BMC) obtained by mixing calcium carbonate and glass fibers with an unsaturated polyester, a millable silicone rubber, or a millable urethane rubber. The content of the soft magnetic powder in the composite material is, for example, 30 vol % or more and 80 vol % or less, based on the total volume of the composite material taken as 100 vol %. The content of the soft magnetic powder in the composite material may further be 50 vol % or more, 60 vol % or more, or 70 vol % or more.

The magnetic core 3 includes an inner core part 31 and an outer core part 32. The inner core part 31 is disposed inside the winding part 21 of the coil 2, and extends along the axis of the winding part 21. The number of inner core parts 31 is the same as the number of winding parts 21. Since the number of winding parts 21 in the present embodiment is one, the number of inner core parts 31 in the present embodiment is also one. In the present embodiment, opposite end portions of a section of the magnetic core 3 that extends along the axis of the winding part 21 protrude from end faces of the winding part 21. The protruding portions also constitute a part of the inner core part 31.

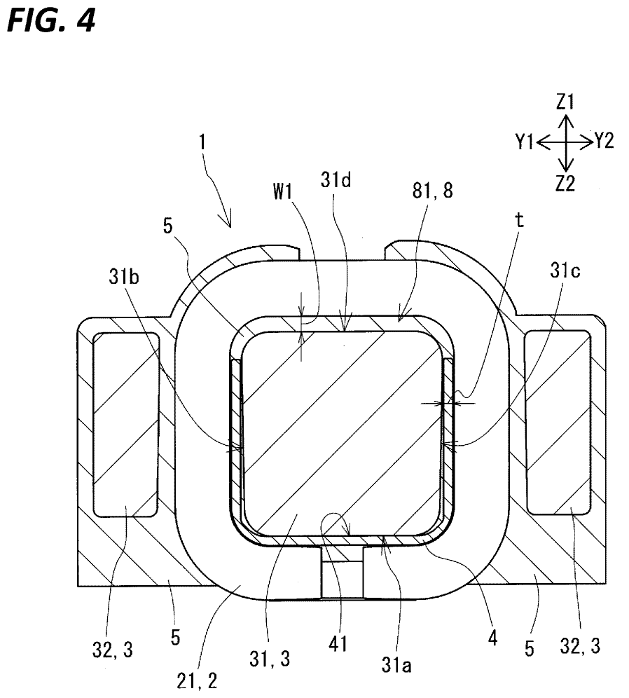

The inner core part 31 has a quadrangular prism shape. Since the winding part 21 of the present embodiment has a rectangular tubular shape, the inner core part 31 has a shape that conforms to the internal shape of the winding part 21. The inner core part 31 is composed of a first core portion 311 and a second core portion 312. As shown in FIG. 4, clearances 8 are formed between the inner core part 31 and the winding part 21. Some of the clearances 8 are closed by a first spacer 4, which will be described later. A portion of the mold member 5, which will be described later, is disposed in a first clearance 81 of the clearances 8 that is not closed by the first spacer 4.

A width W1 of the first clearance 81 is, for example, 0.5 mm or more and 4.0 mm or less. When the width W1 is 0.5 mm or more, the resin that forms the mold member 5 is easily disposed in the first clearance 81 at the time of forming the mold member 5. When the width W1 is 4.0 mm or less, the heat of the inner core part 31 easily escapes to the winding part 21. Therefore, the heat dissipation of the reactor 1 is improved. When the width W1 is 4.0 mm or less, the inside dimension of the winding part 21 can be reduced, as a result of which the outside dimension of the winding part 21 can be reduced. Accordingly, the reactor 1 having a width W1 of 4.0 mm or less is small. Furthermore, the width W1 may be 0.8 mm or more and 3.0 mm or less.

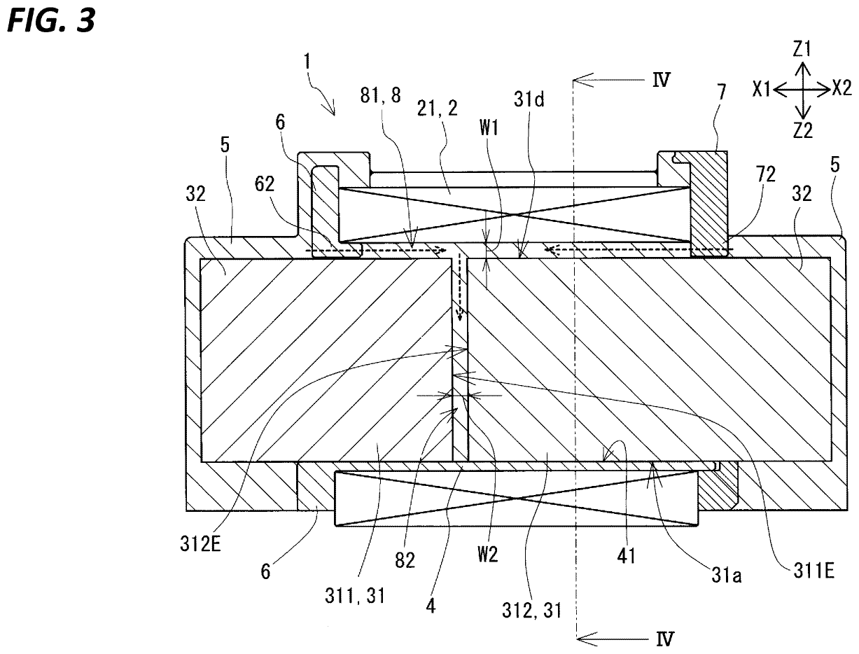

As shown in FIG. 3, a first end face 311E of the first core portion 311 is disposed inside the winding part 21. Likewise, a second end face 312E of the second core portion 312 is also disposed inside the winding part 21. The first end face 311E and the second end face 312E are separated in a direction extending along the axis of the inner core part 31. That is, a second clearance 82 is formed between the first end face 311E and the second end face 312E. A portion of the mold member 5, which will be described later, is disposed in the second clearance 82. The mold member 5 disposed in the second clearance 82 functions as a gap that adjusts the magnetic properties of the magnetic core 3.

A width W2 of the second clearance 82 is, for example, 0.8 mm or more and 4.0 mm or less. When the width W2 is 0.8 mm or more, the resin that forms the mold member 5 easily enters the second clearance 82 at the time of forming the mold member 5. When the width W2 is 4.0 mm or less, the leakage of magnetic flux in the second clearance 82 is reduced. Accordingly, the loss due to leaking magnetic flux is reduced. Furthermore, the width W2 may be 1.0 mm or more and 3.0 mm or less.

The outer core part 32 is constituted by portions of the magnetic core 3 that are disposed outside the winding part 21. The shape of the outer core part 32 is not particularly limited as long as the shape connects end portions of the inner core part 31. As shown in FIG. 2, the outer core part 32 of the present embodiment is composed of an end core portion facing an end face of the winding part 21 in the X1 direction, an end core portion facing an end face of the winding part 21 in the X2 direction, a side core portion facing a side surface of the winding part 21 in the Y1 direction, and a side core portion facing a side surface of the winding part 21 in the Y2 direction. The outer core part 32 has a rectangular annular shape as viewed in the Z2 direction. Unlike the present embodiment, the number of side core portions may be one. In addition, in a case where the number of winding parts 21 and the number of inner core parts 31 are two, the outer core part 32 is composed of, for example, an end core portion connecting end portions of the two inner core parts 31 and 31 in the X1 direction, and an end core portion connecting end portions of the two inner core parts 31 and 31 in the X2 direction.

The magnetic core 3 of the present embodiment is composed of a first core piece 3A and a second core piece 3B. The first core piece 3A includes the first core portion 311 of the inner core part 31, and a portion of the outer core part 32. The first core piece 3A is substantially T-shaped as viewed in the Z2 direction. The second core piece 3B includes the second core portion 312 of the inner core part 31, and a portion of the outer core part 32. The second core piece 3B is substantially E-shaped as viewed in the Z2 direction. The shapes of the core pieces 3A and 3B are not particularly limited. For example, both the first core piece 3A and the second core piece 3B may be substantially E-shaped as viewed in the Z2 direction. In addition, the magnetic core 3 may be composed of three or more divided cores. In a case where the number of winding parts 21 and the number of inner core parts 31 are two, each of the first core piece 3A and the second core piece 3B is U-shaped, for example.

The first core piece 3A of the present embodiment is formed of a powder compact. The second core piece 3B of the present embodiment is formed of a composite material.

### <<First Spacer>>

As shown in FIG. 3, the first spacer 4 is disposed between the winding part 21 and the inner core part 31. The first spacer 4 of the present embodiment has substantially the same length as the entire length of the inner core part 31 along the axis. Unlike the present embodiment, the length of the first spacer 4 of the present embodiment may be shorter than the entire length of the inner core part 31.

As shown in FIG. 4, the first spacer 4 has a trough shape including an inner peripheral surface 41 opposed to, among four outer peripheral surfaces 31a, 31b, 31c, and 31d of the inner core part 31, three outer peripheral surfaces 31a, 31b, and 31c. The outer peripheral surfaces 31a, 31b, 31c, and 31d of the inner core part 31 are surfaces opposed to an inner peripheral surface of the winding part 21. The outer peripheral surface 31a is a surface oriented in the Z2 direction. The outer peripheral surface 31b is a surface oriented in the Y1 direction. The outer peripheral surface 31c is a surface oriented in the Y2 direction. The outer peripheral surface 31d is a surface oriented in the Z1 direction.

The inner peripheral surface 41 of the first spacer 4 covers the entirety of the outer peripheral surface 31a, at least a portion of the outer peripheral surface 31b, and at least a portion of the outer peripheral surface 31c. That is, the first spacer 4 having a trough shape presses the three outer peripheral surfaces 31a, 31b, and 31c of the inner core part 31 having a quadrangular prism shape. Consequently, the inner core part 31 within the winding part 21 is disposed at a predetermined position. Accordingly, the position of the inner core part 31 is less likely to move when the resin that forms the mold member 5 is filled into the first clearance 81.

As described above, the first spacer 4 includes the inner peripheral surface 41 opposed to the entirety of the outer peripheral surface 31a of the inner core part 31 and at least a portion of each of the outer peripheral surfaces 31b and 31c. That is, the first spacer 4 covers more than 25% of the perimeter of the inner core part 31. In other words, the length of the inner peripheral surface 41 of the first spacer 4 in a transverse cross section orthogonal to the axis of the inner core part 31 is greater than 25% of the perimeter of the inner core part 31. On the other hand, the first spacer 4 does not cover the outer peripheral surface 31d of the inner core part 31. Accordingly, the length of the inner peripheral surface 41 of the first spacer 4 in the above-described transverse cross section is 75% or less of the perimeter of the inner core part 31. The length of the inner peripheral surface 41 of the first spacer 4 in the above-described transverse cross section may be, for example, 30% or more, 35% or more, 45% or more, or 65% or more of the perimeter of the inner core part 31. In particular, when the length of the inner peripheral surface 41 of the first spacer 4 in the above-described transverse cross section is 45% or more of the perimeter of the inner core part 31, the mold member 5 can easily enter the second clearance 82 regardless of the size of the second clearance 82.

In the present embodiment, substantially no clearance is formed between the first spacer 4 and the inner core part 31, and between the first spacer 4 and the winding part 21. In the present specification, “substantially no clearance is formed between two members” means that the clearance between the two members is 0.1 mm or less. Unlike the present embodiment, a clearance may be formed between the first spacer 4 and the inner core part 31, and between the first spacer 4 and the winding part 21. In such a case, the clearance is, for example, 0.5 mm or less.

A thickness t of the first spacer 4 is, for example, 0.5 mm or more and 2.0 mm or less. When the thickness t is 0.5 mm or more, a sufficient electrical insulation distance is secured between the winding part 21 and the inner core part 31. When the thickness t is 2.0 mm or less, the heat of the inner core part 31 easily escapes to the winding part 21. Accordingly, the heat dissipation of the reactor 1 is improved. When the thickness t is 2.0 mm or less, the inside dimension of the winding part 21 can be reduced, as a result of which the outside dimension of the winding part 21 can be reduced. Therefore, the reactor 1 having a thickness t of 2.0 mm or less is small. The thickness t further may be 0.8 mm or more and 2.0 mm or less.

The first spacer 4 is formed of an insulating material. The material is, for example, a PPS resin, a PTFE resin, an LCP, a PA resin, a PBT resin, or an ABS resin. In addition, the material of the first spacer 4 may be, for example, a thermosetting resin such as an unsaturated polyester resin, an epoxy resin, a urethane resin, or a silicone resin. These resins may contain a ceramic filler. The ceramic filler is, for example, nonmagnetic powder of alumina, silica, or the like.

The first spacer 4 of the present embodiment is integrated into a single piece with a second spacer 6, which will be described later. In this case, the material of the second spacer 6 is the same as the material of the first spacer 4. The configuration of the second spacer 6 will be described later.

### <<Mold Member>>

As shown in FIG. 1, the mold member 5 integrates the coil 2 and the magnetic core 3 (FIG. 2) into a single piece. The mold member 5 covers at least a portion of an outer peripheral surface of the coil 2, and at least a portion of an outer peripheral surface of the magnetic core 3. In the present embodiment, a portion of the winding part 21 of the coil 2 is exposed from the mold member 5. The portion of the winding part 21 that is exposed from the mold member 5 contributes to an improvement in the heat dissipation of the reactor 1.

The mold member 5 is formed of, for example, a thermoplastic resin such as a PPS resin, a PTFE resin, an LCP, a PA resin, a PBT resin, or an ABS resin. In addition, the mold member 5 may be formed of a thermosetting resin such as an unsaturated polyester resin, an epoxy resin, a urethane resin, or a silicone resin. By including a ceramic filler in these resins, the heat dissipation of the mold member 5 is improved. The ceramic filler is, for example, nonmagnetic powder of alumina, silica, or the like.

As shown in FIG. 3, a portion of the mold member 5 is disposed between the first clearance 81 and the second clearance 82. In the case of forming the mold member 5, an assembly of the coil 2 and the magnetic core 3 is disposed in a mold, and the resin that forms the mold member 5 is filled into the mold. As indicated by the dashed arrows in FIG. 3, the resin is filled into the winding part 21 from the first clearance 81 at an end portion of the winding part 21. Furthermore, as indicated by the downward dashed arrow, the resin is filled into the second clearance 82 from the first clearance 81.

### <<Second Spacer>>

As shown in FIG. 2, the reactor 1 according to the present embodiment further includes two second spacers 6 and 7.

The second spacers 6 and 7 are frame-shaped members having through holes 60 and 70. The second spacers 6 and 7 are each disposed between an end face of the winding part 21 and an end core portion of the outer core part 32. The second spacers 6 and 7 ensure the electrical insulation between the winding part 21 and the outer core part 32. The second spacers 6 and 7 are each formed of a material that can be used for the first spacer 4. Each of the through holes 60 and 70 is larger than the cross section of the inner core part 31, and is smaller than the inner perimeter of the winding part 21. The inner core part 31 extends through the through holes 60 and 70.

The second spacers 6 and 7 include slots 61 and 71 through which the end portions 22 and 23 are passed. The slot 61 has a hole extending in the X1 direction. As a result of the end portion 22 being passed through the slot 61 of the second spacer 6, the position of the second spacer 6 relative to the coil 2 is determined. The slot 71 has a hole extending in the Y2 direction. As a result of the end portion 23 being passed through the slot 71 of the second spacer 7, the position of the second spacer 7 relative to the coil 2 is determined.

Pressing parts 62 and 72 protruding toward the inner side of the through holes 60 and 70 are provided on inner peripheral surfaces of the through holes 60 and 70 of the second spacers 6 and 7. As shown in FIG. 3, the pressing parts 62 and 72 press the outer peripheral surface 31d of the inner core part 31 when the second spacers 6 and 7 are disposed between the outer core part 32 and the winding part 21. That is, the inner core part 31 is supported from four directions by the inner peripheral surface 41 of the first spacer 4, and the pressing parts 62 and 72 of the second spacers 6 and 7. Accordingly, the position of the inner core part 31 inside the winding part 21 is determined.

In the present embodiment, the second spacer 6 and the first spacer 4 constitute a single integral piece. An end portion of the first spacer 4 is fitted in the through hole 70 of the second spacer 7. Through this fitting, the first spacer 4, the second spacer 6, and the second spacer 7 are mechanically coupled to each other, whereby their relative positions are determined. In this case, at the time of producing the reactor 1, the position of the first spacer 4 inside the winding part 21 is easily fixed. Therefore, the first spacer 4 is less likely to move when the resin that forms the mold member 5 is filled into the winding part 21.

Unlike the present embodiment, the first spacer 4 may be integrated into a single piece with each of the second spacer 6 and the second spacer 7. For example, a portion of the first spacer 4 shown in FIG. 3 may constitute a single integral piece with the second spacer 6, and the remaining portion of the first spacer 4 may constitute a single integral piece with the second spacer 7. In that case, inside the winding part 21, an end face of the first spacer 4 integrated into a single piece with the second spacer 6, and an end face of the first spacer 4 integrated into a single piece with the second spacer 7 are abutted against each other.

### <<Manufacturing Method of Reactor>>

In the case of producing the reactor 1 described above, an assembly in which the coil 2, the magnetic core 3, the first spacer 4, and the second spacers 6 and 7 are combined is produced, and the assembly is placed in a mold. Subsequently, a resin serving as the material of the mold member 5 is filled into the mold. As indicated by the dashed arrow in FIG. 3, the resin enters the inside of the first clearance 81 from an end portion of the winding part 21. At this time, in the first clearance 81 formed by narrowing the clearance 8 by the first spacer 4, the pressure of the resin is kept high. Accordingly, the resin is easily filled into the first clearance 81 without the pressure of the resin filled into the mold having to be increased. The resin whose pressure is kept high forcefully enters the second clearance 82 from the first clearance 81. Accordingly, the resin spreads throughout the second clearance 82, and defects such as voids are less likely to be formed in the mold member 5 formed in the second clearance 82 as a result of the resin being solidified. The mold member 5 is connected to the second clearance 82 through the first clearance 81 from the outside of the winding part 21. Moreover, the mold member 5 disposed in the second clearance 82 bonds the first core portion 311 and the second core portion 312 together. Accordingly, the reactor 1 in which the coil 2 and the magnetic core 3 are firmly integrated into a single piece by the mold member 5 is produced.

The mold member 5 disposed in the second clearance 82 functions as a heat transmission path, and allows the heat of the inner core part 31 to escape to the outside of the inner core part 31. The mold member 5 disposed in the entirety of the second clearance 82 improves the heat dissipation of the reactor 1. In particular, in the reactor 1 according to the present embodiment, defects such as voids are less likely to be formed in the mold member 5 disposed in the second clearance 82 inside the winding part 21. Accordingly, it is possible to suppress a reduction in the thermal conductivity from the inside to the outside of the inner core part 31 and a reduction in the function of the mold member 5 as a resin gap due to defects.

In the present embodiment, at the time of forming the mold member 5, the position of the inner core part 31 inside the winding part 21 is determined by the first spacer 4. Accordingly, the distance between the inner core part 31 and the winding part 21 can be reduced, or in other words, the size of the winding part 21 can be reduced. Therefore, the reactor 1 according to the present embodiment is small and lightweight.

### Embodiment 2

### <<Converter and Power Conversion Device>>

The reactor 1 according to the above-described embodiment can be used for applications that satisfy the following conducting conditions. The conducting conditions include, for example, a maximum direct current of about 100 A or more and 1000 A or less, an average voltage of about 100 V or more and 1000 V or less, and a working frequency of about 5 kHz or more and 100 kHz or less. The reactor 1 according to the embodiment typically can be used as a constituent component of a converter placed in a vehicle such as an electric automobile or a hybrid automobile, or a constituent component of a power conversion device including such a converter.

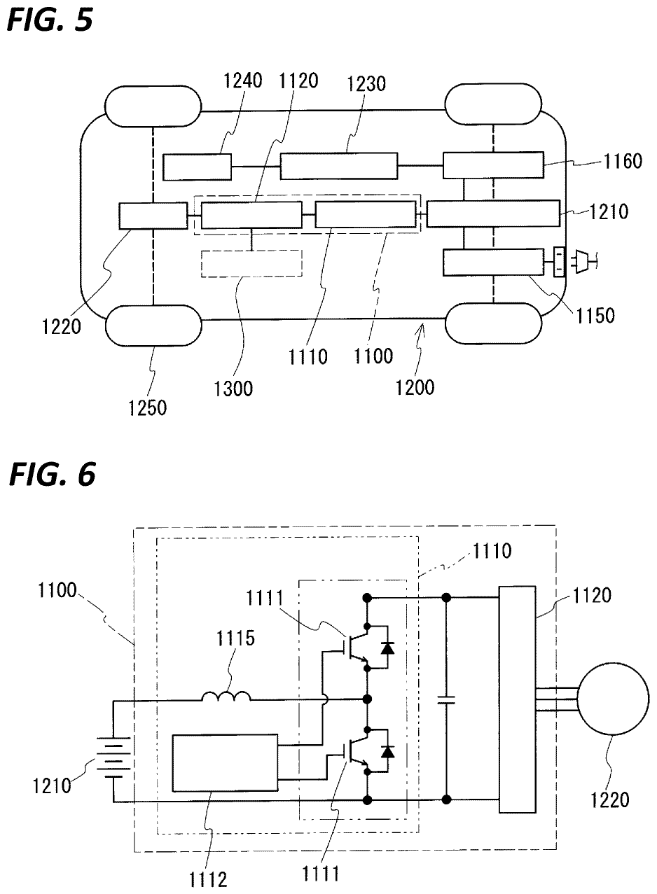

As shown in FIG. 5, a vehicle 1200 such as a hybrid automobile or an electric automobile includes a main battery 1210, a power conversion device 1100 that is connected to the main battery 1210, and a motor 1220 that is driven by the power supplied from the main battery 1210 and is used for traveling. The motor 1220, which is typically a three-phase alternating-current motor, drives wheels 1250 during travel, and functions as a generator during regeneration. In the case of a hybrid automobile, the vehicle 1200 includes an engine 1300 in addition to the motor 1220. Although FIG. 5 shows an inlet as a portion for charging the vehicle 1200, it is also possible to adopt a configuration in which a plug is provided.

The power conversion device 1100 includes a converter 1110 that is connected to the main battery 1210, and an inverter 1120 that is connected to the converter 1110 and that converts direct current to alternating current and vice versa. While the vehicle 1200 is traveling, the converter 1110 shown in the present embodiment steps up the input voltage of the main battery 1210, from about 200 V or more and 300 V or less to about 400 V or more and 700 V or less, and feeds the power to the inverter 1120. During regeneration, the converter 1110 steps down the input voltage that is output from the motor 1220 through the inverter 1120, to a direct-current voltage suitable for the main battery 1210, and charges the main battery 1210. The input voltage is a direct-current voltage. While the vehicle 1200 is traveling, the inverter 1120 converts the direct current whose voltage has been stepped up by the converter 1110, to a predetermined alternating current, and feeds the power to the motor 1220. During regeneration, the inverter 1120 converts the alternating current output from the motor 1220 to a direct current, and outputs the direct current to the converter 1110.

As shown in FIG. 6, the converter 1110 includes a plurality of switching elements 1111, a drive circuit 1112 that controls the operation of the switching elements 1111, and a reactor 1115, and converts an input voltage by repeating ON/OFF operations. Here, converting an input voltage means that an input voltage is stepped up/stepped down. Power devices such as field-effect transistors or insulated gate bipolar transistors are used as the switching elements 1111. The reactor 1115 has the function of smoothing any change in current when a current is about to increase or decrease in response to a switching operation, using the properties of the coil to prevent changes in a current that is attempting to flow through the circuit. The reactor 1 according to the embodiment is provided as the reactor 1115.

The vehicle 1200 includes, in addition to the converter 1110, a power feeding device converter 1150 that is connected to the main battery 1210, and an auxiliary equipment power supply converter 1160 that is connected to the main battery 1210 and a sub-battery 1230 serving as the power source for auxiliary equipment 1240, and that converts a high voltage of the main battery 1210 to a low voltage. The converter 1110 typically performs DC-DC conversion, whereas the power feeding device converter 1150 and the auxiliary equipment power supply converter 1160 perform AC-DC conversion. There is also a power feeding device converter 1150 that performs DC-DC conversion. A reactor having the same configuration as the reactor 1 according to the embodiment, with the size, shape, and the like of the reactor being changed as appropriate, can be used as a reactor for the power feeding device converter 1150 and the auxiliary equipment power supply converter 1160. The reactor 1 according to the embodiment can also be used for a converter that converts input power and that only steps up or steps down the voltage.

### <Test Examples>

In test examples, the influence of the first spacer 4 on the filling state of the resin into the second clearance 82 was examined using a Moldex 3D manufactured by JSOL CORPORATION. The Moldex 3D is resin flow analysis software.

The dimensions of main parts of the examined samples are as follows. The width W1 is the width of the first clearance 81. The width W2 is the width of the second clearance 82. The height percentage is the percentage of the first spacer 4 covering the outer peripheral surfaces 31b and 31c of the inner core part 31, with the length of the inner core part 31 in the Z1 direction taken as 100%. The coverage percentage is the percentage of the first spacer 4 covering the inner core part 31, with the perimeter of the inner core part 31 taken as 100% in a transverse cross section orthogonal to the axis of the inner core part 31.
Sample 1 . . . width W1=2.0 mm, width W2=2.0 mm, height percentage=80%, coverage percentage=65%
Sample 2 . . . width W1=2.0 mm, width W2=2.0 mm, height percentage=40%, coverage percentage=45%
Sample 3 . . . width W1=2.0 mm, width W2=2.0 mm, height percentage=20%, coverage percentage=35%
Sample 4 . . . width W1=2.0 mm, width W2=1.5 mm, height percentage=80%, coverage percentage=65%
Sample 5 . . . width W1=2.0 mm, width W2=1.5 mm, height percentage=40%, coverage percentage=45%
Sample 6 . . . width W1=2.0 mm, width W2=1.5 mm, height percentage=20%, coverage percentage=35%

For Samples 1 to 5, it was found that the resin was sufficiently filled throughout the second clearance 82. On the other hand, for Sample 6, it was found that a portion in which the resin was not filled was formed at an end portion of the second clearance 82 in the Z2 direction. As a result of examining the pressure difference between the inside and the outside for Samples 1 to 5, the pressure difference between the inside and the outside for Samples 1 to 3 was 0.4 MPa or less, the pressure difference between the inside and the outside for Samples 4 and 5 was 2.0 MPa or less. The term “pressure difference between the inside and the outside” refers to a pressure difference between the pressure of the resin on the outer periphery of the outer core part 32, and the pressure of the resin at the center of the second clearance 82 in the Z1 direction. On the other hand, the pressure difference between the inside and the outside for Sample 6 was above 2.0 MPa. From these results, it was found that the above-described pressure difference between the inside and the outside being 2 MPa or less was an indication that the resin was filled throughout the second clearance 82.

From the test results, it was found that, when the first spacer 4 had a size covering 45% or more of the perimeter of the inner core part 31, the resin could be sufficiently filled into the second clearance 82, regardless of the thickness of the second clearance 82. On the other hand, from comparison between Sample 3, in which the width W2 of the second clearance 82 was 2.0 mm, and Sample 6, in which the width W2 of the second clearance 82 was 1.5 mm, it was found that, depending on the width W2 of the second clearance 82, it was possible to sufficiently fill the resin into the second clearance 82 even when the first spacer 4 had a size covering 45% or less of the perimeter of the inner core part 31.

### LIST OF REFERENCE NUMERALS

1 Reactor
2 Coil
   21 Winding part
   22, 23 End portion
3 Magnetic core
3A First core piece
3B Second core piece
   31 Inner core part
   31a, 31b, 31c, 31d Outer peripheral surface
   311 First core portion
   311E First end face
   312 Second core portion
   312E Second end face
   32 Outer core part
4 First spacer
   41 Inner peripheral surface
5 Mold member
6,7 Second spacer
   60, 70 Through hole
   61, 71 Slot
   62, 72 Pressing part
8 Clearance
   81 First clearance
   82 Second clearance
1100 Power conversion device
1110 Converter
   1111 Switching element
   1112 Drive circuit
   1115 Reactor
   1120 Inverter
   1150 Power feeding device converter
   1160 Auxiliary equipment power supply converter
   1200 Vehicle
   1210 Main battery
   1220 Motor
   1230 Sub-battery
   1240 Auxiliary equipment
   1250 Wheel
1300 Engine
t Thickness
W1, W2 Width

1. A reactor comprising:
a coil including a winding part;
a magnetic core including an inner core part disposed inside the winding part, and an outer core part disposed outside the winding part;
a first spacer disposed between the winding part and the inner core part; and
a mold member that integrates the coil and the magnetic core into a single piece, wherein
the inner core part has a quadrangular prism shape, and includes a first core portion having a first end face disposed inside the winding part, and a second core portion having a second end face spaced apart from the first end face,
the first spacer has a trough shape including an inner peripheral surface opposed to three outer peripheral surfaces of the inner core part, and
a portion of the mold member is disposed in a first clearance between the winding part and a portion of the inner core part to which the inner peripheral surface is not opposed, and a second clearance between the first end face and the second end face.

2. The reactor according to claim 1, wherein
the first spacer covers 45% or more of a perimeter of the inner core part.

3. The reactor according to claim 1, further comprising
a second spacer disposed between an end face of the winding part and the outer core part, wherein
the first spacer and the second spacer constitute a single integral piece.

4. The reactor according to claim 1, wherein
the first spacer has a thickness of 0.5 mm or more and 2.0 mm or less.

5. The reactor according to claim 1, wherein
the first clearance has a width of 0.5 mm or more and 4.0 mm or less.

6. The reactor according to claim 1, wherein
the second clearance has a width of 0.8 mm or more and 4.0 mm or less.

7. The reactor according to claim 1, wherein
the magnetic core is formed by combining
a first core piece including a portion of the outer core part and the first core portion, and
a second core piece including a portion of the outer core part and the second core portion.

8. A converter comprising the reactor according to claim 1.

9. A power conversion device comprising the converter according to claim 8.
